(19) United States
(12) Patent Application Publication
(10) Pub. No.: US 2007/0018425 A1
(43) Pub. Date: Jan. 25, 2007

(54) Cart restraining system

(76) Inventors: Cindy Robin Gilmore, Northridge, CA (US); John Gilmore, Northridge, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/378,069

(22) Filed: Mar. 17, 2006

Related U.S. Application Data
(60) Provisional application No. 60/662,753, filed on Mar. 17, 2005.

(51) Int. Cl. B62J 39/00

(52) U.S. Cl. 280/288.4

(57) ABSTRACT

An apparatus and method for restraining a cart is disclosed. Two fasteners and an extender can be configured to prevent a shopping cart from rolling while the cart is being unloaded, for example. Various options for fastening the cart to a vehicle or other immobile object are disclosed.

### REFERENCE TO RELATED APPLICATIONS

This application claims priority to U.S. Provisional Patent Application No. 60/662,753, filed Mar. 17, 2005, the entirety which is hereby incorporated by reference herein and made part of this specification.

### BACKGROUND OF THE INVENTIONS

1. Field of the Inventions

The disclosed inventions relate generally to a system and apparatus for restraining a cart from unwanted motion.

2. Description of the Related Art

Rolling carts commonly roll away from the user in an inconvenient and undesirable way. For example, if the surface of a parking lot is uneven or sloped, it can be difficult to find a way to stabilize a shopping cart when the shopper is attempting to unlock the car door or unload the groceries. Frequently, both hands are needed to unload heavy items from a shopping cart and place them into a shopper's vehicle. At the same time, however, at least one hand is needed to retain the shopping cart from rolling away and causing damage to other vehicles or to the contents of the cart.

If a child is riding in a shopping cart, the situation can be further complicated because it often takes both hands for an adult to lift the child from the cart. Alternatively, if an adult's attention is momentarily diverted to unlocking or loading a vehicle, the cart may roll away with the child, endangering the child.

Thus, there is a need for a device or system for preventing carts from inconveniently rolling away.

### BRIEF DESCRIPTION OF THE DRAWINGS

The inventions will be better understood from the Detailed Description of the Preferred Embodiments and from the appended drawings, which are meant to illustrate and not to limit the inventions, and wherein:

FIG. 1 illustrates a system for retaining a cart from unwanted motion;

FIG. 2 is a schematic perspective view of a cart restraining system;

FIG. 3 is a schematic depiction of how the cart restraining system of FIG. 1 can be used to keep a shopping cart from rolling away while groceries are unloaded;

FIG. 4 is a photograph of one embodiment of a cart restraining system attached to a shopping cart;

FIG. 5 is a photograph of a fastener that connects an embodiment of a cart restraining system to a shopping cart;

FIG. 6 is a photograph of a portion of a cart restraining system that is not attached to a cart; and

FIG. 7 is a photograph of a hook that can be used as a temporary fastener for a cart restraining system.

### DETAILED DESCRIPTION OF THE PREFERRED EMBODIMENTS

A device or system for preventing carts from rolling away would be useful for shoppers individually, as well as for retail establishments. For example, a system can be designed for use by an individual shopper who carries the device in the shopper's vehicle. Alternatively, a system can be designed for use by a retail establishment that adds a device to each shopping cart, for example. Such an addition may give a retail establishment a competitive edge in providing convenience for customers. The device may also allow a retail establishment with a particularly steep parking arrangement to effectively level the playing field.

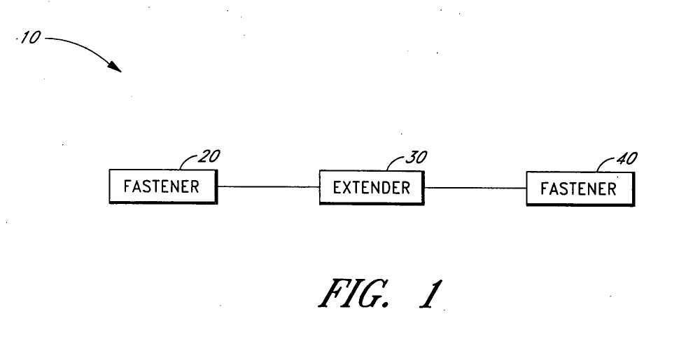

FIG. 1 shows how a system can be configured to retain a cart from unwanted motion. At one end of the system 10 is a fastener 20 that connects the system 10 to the cart (not shown). At the other end of the system 10 is another fastener 40 that connects the system to another object, such as a stationary object (not shown). In between the two fasteners is an extender 30 that maintains a distance between the other object and the cart when the cart is being restrained. The system 10 is preferably designed to be easily installed, weather-resistant, and mechanically durable.

The fastener 20 can create a temporary or a permanent connection to the cart. In some embodiments, the fastener can insure that the system cannot be easily removed from the cart. This can be accomplished by mechanically coupling the fastener 20 to the cart with metal rivets or welding, for example. In some embodiments, the connection can be made using a locking zip tie. Preferably, the locking zip tie can be employed in conjunction with a sheath (not shown) that limits how tight the zip tie can be sinched down, thus allowing the zip tie to form a ring-like shape. The sheath can also add rigidity and strength to the connection. A locking zip tie can be installed quickly and easily, but can also be difficult to remove, once the zip tie is locked. In some embodiments, the connection can be accomplished using a D-shaped or C-shaped metal ring. In other embodiments, the connection can be accomplished using a flexible cord that has its two ends fastened together (using a locking zip tie, for example) after being threaded through a portion of the cart. Other materials can also be used as the fastener 20. A chain, cable, cord, or strap can also be used, as well as other similar materials. Indeed, any material may be used that provides enough strength to prevent the connection from breaking under the load it is designed to bear. In a preferred embodiment, a rope or a bungee cord is used to connect the device 10 to a cart. The more permanent approach can be useful if the system 10 is provided by the owner of the cart and is intended to remain with the cart permanently as a convenience for all who use the cart.

Other embodiments of a fastener 20 can provide a more temporary connection to the cart, using mechanical or magnetic coupling, for example. In some embodiments, such a temporary connection can be made using velcro, a magnet, a removable hook or hooks, a cord, a snap, a button, a clasp, or other securement means, etc. In some embodiments, the fastener 20 can be a carabiner of the type commonly employed by rock climbers. The less permanent approach can be useful if the cart does not have its own restraint system and the user of the cart wishes to fasten a system 10 to the cart for temporary use.

The fastener 40 at the other end of the system 10 connects the system 10 to a stationary object. The fastener 40 can create a temporary or a permanent connection to the stationary object, but in a preferred embodiment the fastener 40 creates a temporary connection. Various fasteners can be used to create this connection, including those discussed above in relation to the fastener 20. If one of the fasteners 20 or 40 is permanently attached to the cart or a stationary object, preferably the other fastener is not also permanently attached, so that the cart can be mobile when desired by the user. If the system 10 is permanently fastened to a stationary object, the system can be used to keep a group of carts from rolling away from a cart collection area, for example. In some embodiments, the fastener 40 is temporary so it can be connected to a shopper's vehicle, for example. In another embodiment, either of the fasteners 20 or 40 can connect to another cart, thereby coupling two or more carts together.

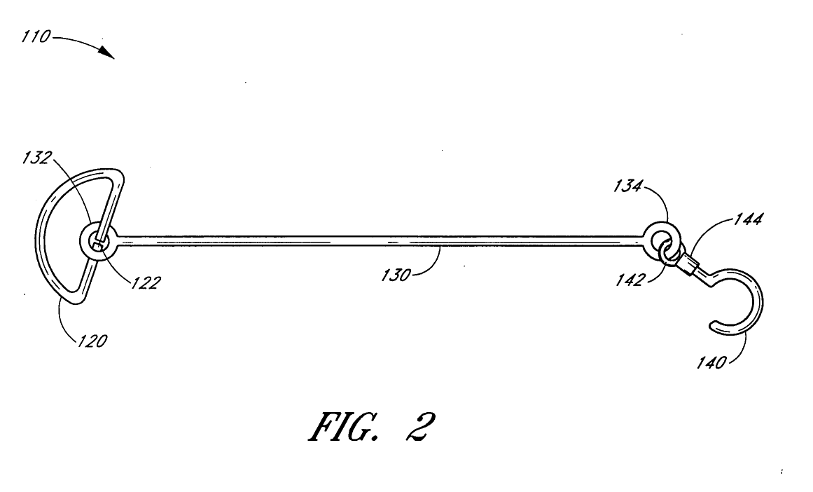

The two fasteners 20 and 40 can each comprise a plurality of fasteners. For example, the fastener 140 (FIG. 2) can include hooks of various sizes and a magnet. This configuration can allow the user to choose which fastener is most appropriate for attaching to a given object.

In between the fastener 20 and the fastener 40 is an extender 30 that provides a length between the stationary object and the cart. While various lengths are contemplated, the length of the extender 30 can be selected to provide maximum convenience for the intended use of the system 10. For example, if the system is designed for permanent connection to a shopping cart, the extender 30 can be designed to hang down from the handle of the cart without dragging on the ground. In some embodiments, the extender is prevented from swinging by an additional clip or other connector (not shown) on the cart. Such a clip can be designed to allow the device to be easily and repeatedly detached for use, and secured again when the device is not in use. In some embodiments, the length is determined by the arm length of an average user. In some embodiments, the length is determined by how much storage room is available in or along a portion of a cart or a vehicle. The extender 30 can be a telescoping or collapsible rod with an adjustable length. The extender 30 can also be nonrigid, and can comprise a bungee cord or a retractable length of cord wrapped around a spring-biased spindle. In some embodiments, the extender can be a chain, wire, cable, cord, rope, strap, bar, or other similar material. In some embodiments, the extender can be contained within a vehicle and retract into a housing therein, or snap into a groove therein. In some embodiments, the extender is partially rigid and partially nonrigid. In a preferred embodiment, the length of the extender is between approximately 18 inches and approximately 24 inches, but the length can be greater or smaller than this in some advantageous embodiments.

The device 10 can provide safety to all as well as convenience to the user. For example, a retail establishment can improve safety in the parking lot by preventing shopping carts from rolling unchecked. Not only will the device reduce the likelihood of runaway carts inflicting damage on parked vehicles and store patrons, but vehicles will also be less likely to collide with carts. Moreover, the disclosed inventions can prevent a shopping cart from damaging the user's own car. Furthermore, people will be less likely to chase rolling carts into the path of oncoming traffic, and children seated in carts will be less likely to crash if the disclosed inventions are employed to prevent carts from rolling unrestrained.

FIG. 2 illustrates one example of a cart restraining device 110 that can be used to prevent a cart from rolling away. The device 110 has a D-shaped fastener 120 on one end, a hook 140 on the other end, and an extender rod 130 that connects the two.

The illustrated D-shaped fastener 120 can be formed from metal or another sturdy material such as plastic. In the illustrated embodiment, the fastener 120 is a rod that has been bent into a D-shape, with the two ends of the rod almost touching at a gap 122. The gap 122 can allow the fastener 120 to surround or fasten to various objects. For example, in some embodiments, the D-shaped fastener 120 can be temporarily bent to fit around a handle or other portion of a shopping cart. Then, the D shape can be restored, making it difficult to remove the fastener 120 from its position encircling the handle without bending the fastener 120 out of shape again. As noted above, in some embodiments, the fastener 120 can be replaced with a carabiner of the type commonly employed by rock climbers. The carabiner has the advantage of a spring-hinged side that can provide for a fast and secure connection. Furthermore, as noted above, the fastener 120 can be replaced with a variety of other fasteners as described above.

The illustrated extender rod 130 can be formed from metal or another sturdy material such as plastic. In the illustrated embodiment, the rod 130 has two integral rings, 132 and 134, formed at each end of the rod 130. The rings 132 and 134 are convenient structures to which the fasteners 120 and 140 can be mechanically coupled. In a preferred embodiment, the rod 130 is approximately 19 inches long, but not longer than approximately 24 inches.

The illustrated hook fastener 140 can be formed from metal or another sturdy material such as plastic. Advantageously, the rod is configured not to scratch or otherwise deface the surface to which it attaches. In a preferred embodiment, the hook 140 is metal, but is coated with a plastic or rubber coating to prevent scratches. Preferably, the hook is approximately 3 inches long. In a preferred embodiment the hook 140 also has a swivel 144 that allows the hook 140 to achieve various orientations with respect to the object to which the hook 140 attaches. The swivel 144 allows the hook to rotate about an axis, allowing it at least one degree of freedom.

In the illustrated embodiment, the hook 140 has a ring 142 that provides a mechanical connection to the ring 134 of the rod 130. The connection between the ring 134 and the ring 142 provides another degree of freedom, allowing the angle between the hook 140 and the rod 130 to change as the ring 142 slides around the ring 134. This connection allows the hook 140 to achieve various orientations with respect to the object to which the hook 140 attaches.

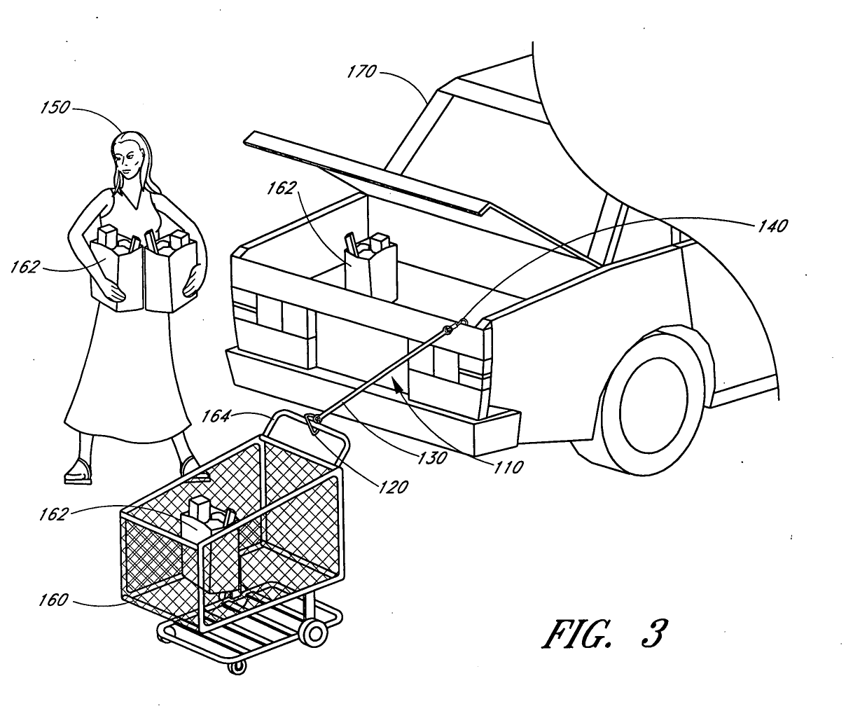

FIG. 3 schematically illustrates an example of how the cart restraining device 110 can be used to prevent a cart 160 from rolling away. A user 150 has used the device 110 to anchor a shopping cart 160 to a stationary vehicle 170 while the user 150 unloads groceries 162 from the shopping cart 160. The device 110 is anchored securely in place so the shopping cart 160 cannot roll away, even if it is located on a steep incline. At one end of the device 110, the D-shaped fastener 120 is attached to a handle 164 on the shopping cart 160. At the other end of the device 110, the hook 140 is removably attached to a convenient portion of the vehicle 170.

In the embodiment of FIG. 3, the D-shaped fastener 120 is attached to the cart so that when the device 110 is not in use, the device 110 can hang down at one end of the handle 164. Then, when the device 110 is needed, the user 150 can lift the rod 130 and hook 140 away from the cart 160 and slide the fastener 120 into a convenient position. The rod 130 is conveniently long enough for the user 150 to stand in between the shopping cart 160 and the vehicle, but not so long as to put the shopping cart 160 beyond the reach of the user 150. The hook is shown fastened to a corner of the open trunk of the vehicle, but other portions of the vehicle may also be conveniently used. For example, the hook 140 could be fastened to a door handle a door frame of an open door, an antenna, a bumper, a spoiler, a louver, a hitch, etc. Alternatively, the hook 140 can be fastened to an adjacent vehicle, or to the belt loop or pocket of the user, if convenient. Although FIG. 3 depicts the device 110 attached to the handle of a shopping cart 160, in some embodiments the device 110 is attached to the other end of the shopping cart 160. This can provide the advantage of safety by keeping a child—who may be seated next to the handle 164 of the shopping cart—away from the device.

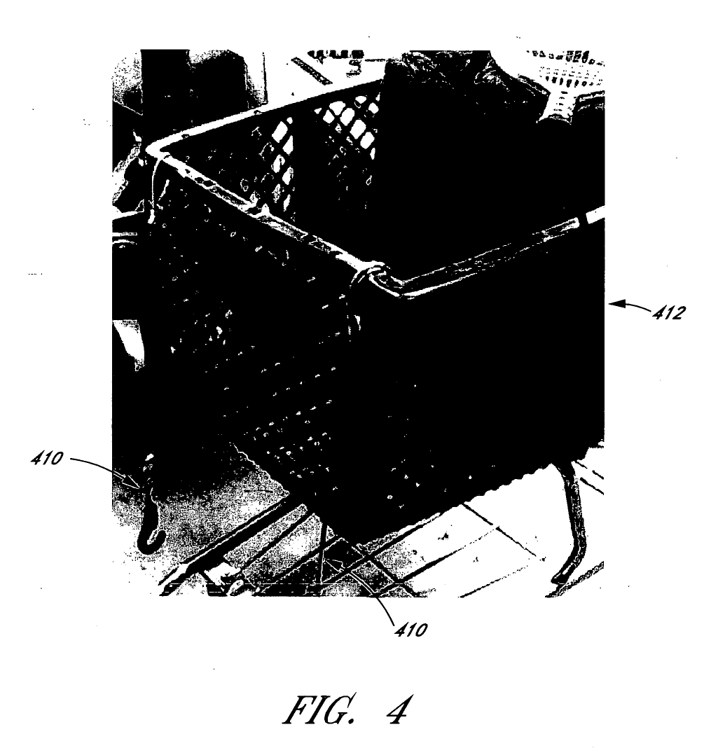

FIG. 4 is a photograph of one embodiment of a cart restraining system attached to a shopping cart 412. In this embodiment, two devices 410 are attached to the shopping cart at the end opposite the handle of the cart. The two devices 410 are not hooked to a stationary object but are hanging down at the side of the cart 412, ready to be deployed.

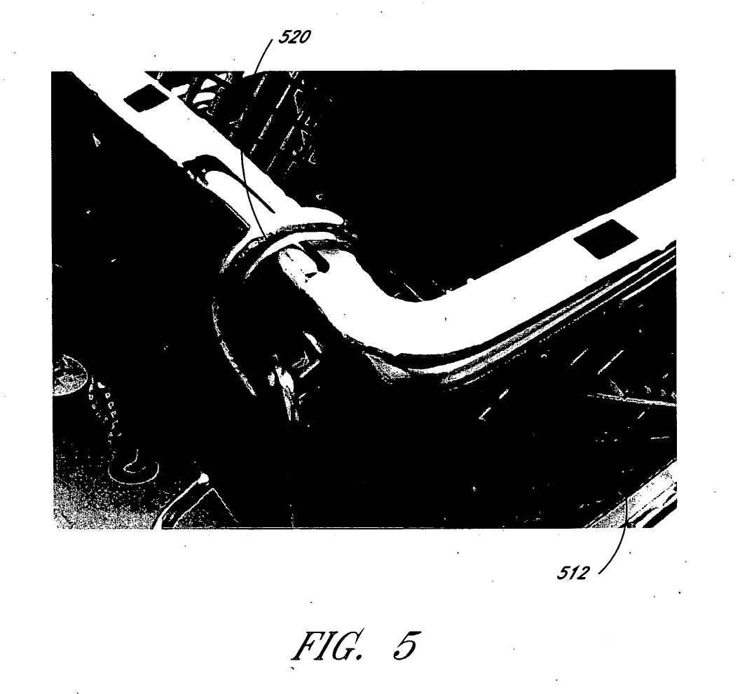

FIG. 5 is a photograph of a connector 520 that connects an embodiment of a cart restraining system to a shopping cart. This close-up view shows how the connector 520 can be threaded through a portion of the shopping cart 512. This figure also illustrates how a locking zip tie inside a plastic sheath can provide a ring-like connection to the shopping cart 512. The plastic sheath can protect the locking zip tie and reinforce the connection. The plastic sheath can also improve the mobility of the connection by allowing the ring-like connection to slide smoothly along or across any physical objects that may be encountered.

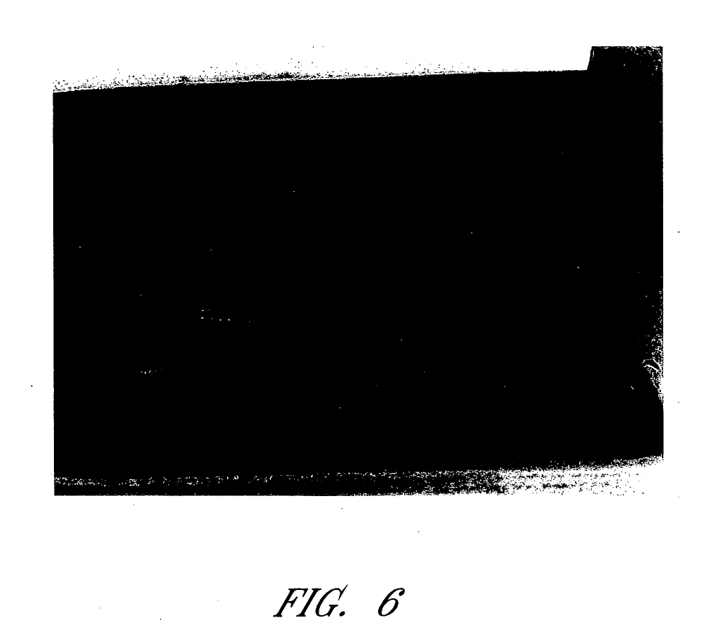

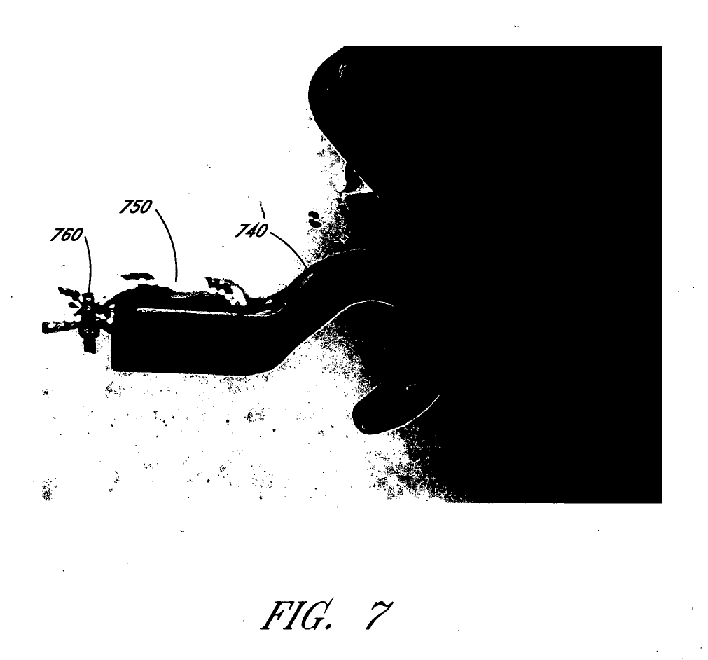

FIG. 6 is a photograph of a portion of a cart restraining system 610 that is not attached to a cart. The system 610 employs a hook 640 at one end that is attached to a metal extender rod 630 with a strong nylon cord 650. The nylon cord 650 forms a loop that is threaded through the metal ring at the end of the extender rod 630. The nylon cord 650 is fastened to the hook using a plastic locking zip tie 660 (also see FIG. 7). The nylon cord 650 connection provides flexibility to the hook 640, which is free to attach to a portion of a vehicle at a convenient angle. Furthermore, the nylon cord 650 is unlikely to scratch or deface the paint of a vehicle.

FIG. 7 is a close-up photograph of a hook 740 that can be used as a temporary fastener for a cart restraining system. This view shows how a plastic locking zip tie 760 helps secure the hook to a nylon cord 750 that has been threaded through a portion of the hook 740.

The foregoing description sets forth various preferred embodiments and other exemplary but non-limiting embodiments of the inventions disclosed herein. The description gives some details regarding combinations and modes of the disclosed inventions. Other variations, combinations, modifications, modes, and/or applications of the disclosed features and aspects of the embodiments are also within the scope of this disclosure, including those that become apparent to those of skill in the art upon reading this specification. Thus, the scope of the inventions claimed herein should be determined only by a fair reading of the claims that follow.

What is claimed is:

1. A retention device for a shopping cart comprising:
a first fastener at a first end of the device configured to connect to a shopping cart;
a second fastener at a second end of the device configured to connect to a stationary object;
an extender extending between and mechanically coupled to said first and second fasteners.

2. The device of claim 1, wherein the first fastener is C-shaped.

3. The device of claim 1, wherein the first fastener comprises a locking zip tie.

4. The device of claim 1, wherein the first fastener is D-shaped.

5. The device of claim 1, wherein the first fastener comprises a carabiner.

6. The device of claim 1, wherein the second fastener is a metal swivel hook.

7. The device of claim 1, wherein the extender is a metal rod with integral rings at each end.

8. A system for retaining a cart from rolling downhill comprising:
a rod, the rod having a first ring at a first end and a second ring at a second end;
a first connector connecting said first ring to a cart; and
at least one second connector connecting said second ring to a stationary object that has greater mass than said cart.

9. The system of claim 8, wherein the first connector has been welded to prevent the rod from being removed from the cart.

10. The system of claim 8, wherein the second connector is a plastic-coated hook.

11. The system of claim 8, wherein the second connector is a magnet.

12. The system of claim 8, wherein the rod is a telescoping rod.

13. The system of claim 8, further comprising an alternative second connector attached to the second ring.

14. A method for preventing runaway shopping carts, comprising:
securing a fastener to a portion of the shopping cart;
providing an extender to the fastener at a first end of the extender;
securing a fastener to a second end of the extender; and
attaching a fastener to a stationary object while unloading the shopping cart; and
detaching the fastener from the stationary object after the shopping cart is unloaded.

15. A device for temporarily preventing a shopping cart from rolling, comprising:
an extender;
means for attaching said extender to a shopping cart; and
means for attaching said extender to a stationary object.

16. The device of claim 15, wherein the extender is between approximately 18 and approximately 24 inches long.

17. The device of claim 15, wherein the extender is approximately 24 inches long.

18. The device of claim 15, wherein the extender is collapsible and extendable, and can be configured to be any length between approximately 0 inches and approximately 36 inches.

19. The device of claim 15, wherein the means for attaching said extender to a shopping cart is a permanent mechanical connection.

20. The device of claim 15, wherein the means for attaching said extender to a stationary object is a coated metal hook with a length of approximately 3 inches.

21. The device of claim 20, wherein the coated metal hook has a swivel.

22. The device of claim 15, wherein the means for attaching said extender to a stationary object is a magnet.
